(19) United States
(12) Patent Application Publication
(10) Pub. No.: US 2011/0132537 A1
(43) Pub. Date: Jun. 9, 2011

(54) COMPOSITION, TAPE, AND USE THEREOF

(75) Inventors: Jeongwan Choi, Kyonggi-Do (KR); Hun Jeong, Gyeonggi-Do (KR); Jae-Sung Kim, Gyeonggi-do (KR)

(73) Assignee: 3M Innovative Properties Company

(21) Appl. No.: 12/630,161

(22) Filed: Dec. 3, 2009

(51) Int. Cl. B32B 37/00; D03D 19/00; B32B 33/00

(52) U.S. Cl. 156/299; 442/1; 428/40.1; 156/60

(57) ABSTRACT

A composition comprises a thermosetting binder, a conductive reinforcing scrim, and low melting point metal particles. The low melting point metal particles melt at or below 350° C. The composition may be made in to a tape. Bonding of the composition to a substrate is also disclosed.

### TECHNICAL FIELD

The present disclosure broadly relates to electrically conductive adhesives, tapes, and uses thereof.

### BACKGROUND

Thermosetting conductive double-sided adhesive tapes such as, for example, CBF 300 conductive tape from Tatsuta, are commonly used to bond a stiffener to a flexible printed circuit board. Typical double-sided conductive pressure-sensitive (PSA) tapes for stiffener bonding applications claim to achieve long term reliability in electrical contact and adhesion. However, there continues to be a need for thermosetting conductive films with better electrical and adhesion reliability.

### SUMMARY

In one aspect, the present disclosure provides a composition comprising: a thermosetting binder, a conductive reinforcing scrim, and conductive fillers including low melting point metal particles, wherein the low melting point metal particles melt at or below 350° C. In some embodiments, the composition is pressure-sensitive. In some embodiments, the thermosetting binder comprises a thermally curable epoxy resin, curative for the thermally curable epoxy resin, and an acrylic polymer. In some of those embodiments, the acrylic polymer is formed by polymerization of acrylic monomers in the presence of the epoxy resin. In some embodiments, the conductive reinforcing scrim comprises at least one of metal coated polymer fibers and metal coated carbon fibers. In some embodiments, the low melting point metal particles comprise a low melting point tin alloy.

In another aspect, the present disclosure provides tapes, films, and sheets comprising a composition according to the present disclosure. In some embodiments, the composition is sandwiched between two release liners.

In yet another aspect, the present disclosure provides a method comprising adhering a composition according to the present disclosure to at least one substrate having a conductive electrical trace. In some embodiments, the substrate is flexible. In some embodiments, the method further comprises adhering the composition to a metallic stiffener.

As used herein:

the term “conductive” means “electrically conductive” unless otherwise indicated; and

the term “electrically conductive” means having a bulk resistance of less than 10⁹ ohms per centimeter.

In some embodiments, electrically conductive compositions and/or articles according to the present disclosure have a bulk resistance of less than 10⁴ ohms per centimeter.

The features and advantages of the present disclosure will be better understood upon consideration of the detailed description as well as the appended claims. These and other features and advantages of the disclosure may be described below in connection with various illustrative embodiments of the disclosure. The above summary is not intended to describe each disclosed embodiment or every implementation of the present disclosure. The Figures and the detailed description which follow more particularly exemplify illustrative embodiments.

### BRIEF DESCRIPTION OF THE DRAWINGS

FIG. 1 is a side view of an exemplary thermosetting electrically conductive tape according to the present disclosure; and

FIG. 2 is a cross-sectional side view of a flexible circuit adhered to a metal stiffener by a thermally cured composition according to the present disclosure.

While the above-identified drawing figures set forth several embodiments of the present disclosure, other embodiments are also contemplated, as noted in the discussion. In all cases, this disclosure presents the disclosure by way of representation and not limitation. It should be understood that numerous other modifications and embodiments can be devised by those skilled in the art, which fall within the scope and spirit of the principles of the disclosure. The figures may not be drawn to scale. Like reference numbers may have been used throughout the figures to denote like parts.

### DETAILED DESCRIPTION

Typically, the thermosetting binder is formed from a thermosetting binder precursor that typically includes at least sufficient curative to cause thermosetting (i.e., an effective amount) thereby forming the thermosetting binder, although some thermosetting binder precursors may not require added thermal curative.

Useful thermosetting binder precursors include, for example, epoxy resins, acrylate resins, phenolic resins, urethane resins, cyanate resins, and combinations thereof. Of these, thermally curable epoxy resins blended with acrylic polymers are desirable. In such systems, the thermally curable epoxy resin and a curative for the epoxy resin is intimately mixed with polyfunctional (meth)acrylic monomers, and then the (meth)acrylic monomers are polymerized to form an acrylic polymer mixed with curable epoxy resin, which may be in the form of a thermally curable tape. As used herein, het prefix “(meth)acryl” includes acryl and/or methacryl. Further details concerning thermosetting binders may be found in U.S. Pat. No. 5,086,088 (Kitano et al.), which is particularly useful if pressure-sensitive adhesive properties are desired. Similar thermosetting binders can be prepared by blending thermoplastic polymers with epoxy resin and thermal curative for the epoxy resin, and at least partially curing the epoxy resin; for example, as described in U.S. Pat. Appln. Publ. No. US 20020182955 (Weglewski et al.) and U.S. Pat. No. 6,406,782 (Johnson et al.).

In the case of epoxy resin-containing thermosetting binder precursors, a thermal curative such as, for example, dicyandiamide or an imidazole curative may be included in amounts up to about 20 weight percent based on a total weight of the thermosetting binder.

The reinforcing scrim may be a woven or nonwoven scrim that has electrical conductivity along fibers of the scrim. Examples include metal-coated woven materials and metal-coated nonwoven materials such as nickel-copper-nickel plated polyethylene terephthalate (PET) polyester nonwoven materials, tin-plated woven materials, and silver-plated carbon fiber nonwoven materials.

Useful additives which can be optionally included in compositions according to the present disclosure include, but are not limited to, fillers, pigments, fibers, woven and nonwoven fabrics, foaming agents, antioxidants, stabilizers, fire retardants, chain transfer agents, and viscosity adjusting agents.

Compositions according to the present disclosure may be formed into various shapes such as, for example, films, sheets, and tapes, optionally in contact with one or two releasably adherable liners (e.g., siliconized paper or polyester, or polyolefin), or a metallic foil or stiffener. Tapes and sheets so formed typically have a thickness approximately the same as the conductive reinforcing scrim; e.g., in a range of from about 20 to 100 micrometers, typically, in a range of from 40 to 70 micrometers, although higher and lower thicknesses may be used.

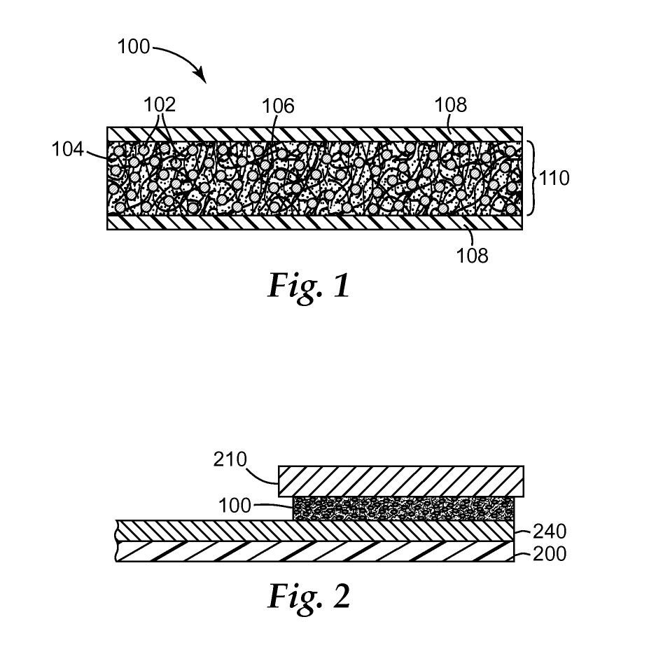

Referring now to FIG. 1, tape 100 comprises composition 110 according to the present disclosure sandwiched between optional releasably adhered liners 108. Composition 110 comprises thermosetting binder 106, conductive reinforcing scrim 104 and low melting point metal particles 102. Once thermally cured, the tape is electrically conductive. Typically, the composition is also electrically conductive prior to curing, however, as long as it is electrically conductive after curing this is not a requirement.

Referring now to FIG. 2, in one exemplary use, tape 100 is sandwiched between flexible circuit 200 and metallic stiffener 210, whereby when tape 100 is thermally cured it secures flexible circuit 200 to metallic stiffener 210, while providing electrical conductivity between at least one circuit element 240 on flexible circuit 200 and metallic stiffener 210.

The conductive reinforcing scrim is typically disposed within the thermosetting tape such that it is coextensive with tape along at least its length and width. Typically, the conductive reinforcing scrim is present in an amount of from about 8 grams per square meter (gsm) to 100 gsm for tapes with a thickness in a range of from about 20 to 100 micrometers.

The low melting point metal particles may be any metallic particles that melt at or below 350° C., typically less than about 275° C., and more typically less than about 225° C. Examples include solder alloys such as 42Sn/58/Bi (melting point (m.p.)=138° C.), 43/Sn/43Pb/14Bi (m.p.=163° C.), 62Sn/36Pb/2Ag (m.p.=179° C.), 63Sn/37Pb (m.p.=183° C.), 60Sn40Pb (m.p.=191° C.), 95.55Sn/4Ag/0.5Cu (m.p.=217° C.), 99.3Sn/0.7Cu (m.p.=227° C.), 95Sn/5Ag (m.p.=245° C.), 10Sn/88Pb/2Ag (m.p.=290° C.), 5SN/95/Pb (m.p.=312° C.). The low melting point metal is typically included in the thermosetting electrically conductive composition in an amount of from about 10 to 80 weight percent, typically 40 to 60 weight percent, based on a total weight of the thermosetting electrically conductive composition, although higher and lower amounts may also be used.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

### Example 1

Adhesive syrups were prepared with the compositions reported in Table 1 (below).

TABLE 1

| | SYRUP 1 | SYRUP 2 |
|---|---|---|
| COMPONENT | (parts) | (parts) |
| 2-hydroxyethyl acrylate prepolymer | 60 | 60 |
| prepared as follows: 100 parts by weight | | |
| of 2-ethylhexyl acrylate was blended | | |
| with 0.04 parts of photoinitiator | | |
| (available as IRGACURE 651 from Ciba | | |
| Specialty Chemicals of Tarrytown, New | | |
| York) and photopolymerized with an | | |
| ultraviolet (UV) light source under | | |
| constant nitrogen purge to a viscosity | | |
| of about 200 cps | | |
| N-vinylcaprolactam | 40 | 40 |
| Bis acylphosphine oxide photoinitiator, | 0.1 | 0.1 |
| available as IRGACURE 819 from Ciba | | |
| Specialty Chemicals | | |
| Bisphenol A diglycidyl ether available | 50 | 50 |
| as EPON 828 from Hexion Specialty | | |
| Chemicals of Columbus, Ohio | | |
| dicyandiamide, available as AMICURE | 5 | 5 |
| CG-1400 from Air Products and | | |
| Chemicals of Allentown, Pennsylvania | | |
| R972, fumed silica available as | 10 | 10 |
| AEROSIL R 972 from Evonik Industries | | |
| of Parsippany, New Jersey | | |
| 42Sn58Bi metal particles, 20-30 microns | — | 100 |
| particle size, obtained from Mitsui | | |
| Kinzoku of Tokyo, Japan | | |

Respective tape specimens Tape 1 and Tape 2 were made by passing 50 micrometer thick conductive nickel-plated polyester nonwoven scrim and copper-plated nonwoven scrims obtained from Ajin Electron of Kangso-Gu, Korea] and the adhesive syrup between transparent silicone release liners through the coating rolls. The gap on the coating rolls was set at 45-48 um which was slightly thinner than the scrim thickness.

The coated adhesive syrup was cured to form a tape by exposure to ultraviolet radiation for 520 seconds under about 3.0 mW/cm² onto the top side and 3.0 mW/cm² of intensity on the bottom side.

Each tape to be evaluated was laminated to Au/Cu foil, the release liner was removed and the tape was adhered to a printed circuit board across electrical traces (spaced 2 millimeters apart) at room temperature for 5 seconds at 15 psi (0.1 MPa). Then, the laminate was press bonded at 300 psi (2.1 MPa) at 210° C. for 2 minutes, then cured at 180° C. for 30 minutes. XYZ-axis electrical resistance was measured between two adjacent electrical traces laminated to the tape and spaced 2 millimeters apart on the printed circuit board. Table 2 (below) reports average XYZ-axis electrical resistance after lamination, after pressing/bonding, and after curing and is reported in Table 2 (below) as an average of five replicates.

TABLE 2

| | | AVERAGE XYZ-AXIS ELECTRICAL | | |
|---|---|---|---|---|
| | | RESISTANCE | | |
| | | | after pressing/ | |
| | | after lamination | bonding | after curing |
| TAPE 1 | SYRUP 1 | 0.6 ohms | 0.2 ohms | 0.9 ohms |
| TAPE 2 | SYRUP 2 | 0.6 ohms | 0.2 ohms | 0.4 ohms |

Table 3 (below) reports 180° peel adhesion according to ASTM D3330 of tape specimens after curing at 180° C. for 30 minutes.

TABLE 2

PEEL ADHESION,
Newtons per 10 millimeters

| | | to polyimide | |
|---|---|---|---|
| | | cover layer | to flex shield |
| TAPE 1 | SYRUP 1 | 12 | 10 |
| TAPE 2 | SYRUP 2 | 12 | 10 |

All patents and publications referred to herein are hereby incorporated by reference in their entirety. All examples given herein are to be considered non-limiting unless otherwise indicated. Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. A composition comprising: a thermosetting binder, a conductive reinforcing scrim, and low melting point metal particles, wherein the low melting point metal particles melt at or below 350° C.

2. The composition of claim 1, wherein the composition is pressure-sensitive.

3. The composition of claim 1, wherein the thermosetting binder comprises a thermally curable epoxy resin, curative for the thermally curable epoxy resin, and an acrylic polymer.

4. The composition of claim 1, wherein the acrylic polymer is formed by polymerization of acrylic monomers in the presence of the epoxy resin.

5. The composition of claim 1, wherein the conductive reinforcing scrim comprises at least one of metal coated polymer fibers and metal coated carbon fibers.

6. The composition of claim 1, wherein the low melting point metal particles comprise a low melting point tin alloy.

7. A tape comprising the composition of claim 1.

8. The tape of claim 8 sandwiched between two release liners.

9. A method comprising adhering the composition of claim 1 to at least one substrate having a conductive electrical trace.

10. The method of claim 9, wherein the substrate is flexible.

11. The method of claim 10, further comprising adhering the composition to a metallic stiffener.
